(19) United States
(12) Patent Application Publication
(10) Pub. No.: US 2025/0214281 A1
(43) Pub. Date: Jul. 3, 2025

(54) DYNAMICALLY ADJUSTABLE MECHANICALLY INFINITE THROW FOR MOLD ACTIVE VIBRATION

(71) Applicant: Columbia Machine, Inc., Vancouver, WA (US)

(72) Inventor: Stacy Gildersleeve, Vancouver, WA (US)

(21) Appl. No.: 18/403,615

(22) Filed: Jan. 3, 2024

(51) Int. Cl. B28B 1/087

(52) U.S. Cl. CPC B28B 1/0873; B28B 2001/0876

(57) ABSTRACT

In a method and apparatus for vibrating a mold box of a type having a plurality of mold cavities sized and shaped to yield a predesignated molded product, the system comprises mounting the mold box to a frame within the expanse of a product forming machine and moving left and right sides of a yoke upward and downward independently through phases of a vibration sequence. The vibration sequence for each has a maximum and minimum lifting height such that the left and right sides of the yoke tilt with respect to one another dependent upon the vibration sequence. A central vibration rod couples between a central portion of the yoke and the frame so that the frame is vibrated at an approximate average between the upward and downward movement of the left and right sides of the yoke. Vibration frequency, amplitude, and phase difference can be adjusted to affect the vibration profile of the central vibration rod.

### BACKGROUND OF THE INVENTION

### 1. Field of the Invention

The present disclosure relates generally to concrete product making machinery, and more particularly to vibration systems and methods for such machinery.

### 2. Description of the Prior Art

Concrete Products Machines are complex machines capable of forming concrete products of varying shapes and sizes quickly and in such a way that the freshly formed concrete can be transported to a curing room for hardening without damage to the product. Concrete products come in a variety of sizes, shapes, and structural requirements which result in different concrete mix designs, ingredients, molds configurations, and resultant settings of the machine. Ingredients range widely worldwide and each change to the mix design requires changes to the forming machine settings. Aggregates can include volcanic cinders, crushed rock of many types, natural river rock, expanded clay and shale, and power station waste fly ash (used to replace cement) to name a few. Likewise, many different types of cement are used as a binder with color oxides and admixes of many types. Finished product shapes, sizes, and heights all require separate molds that are used in the forming machine, and each requires different settings of the forming machine. And finally, structural requirements of the finished products change from product to product. A concrete paver may require extremely high densities, strengths, and resistance to liquid absorptions. A lightweight masonry unit may have a low minimum strength requirement with a maximum desired unit weight. An architectural masonry unit will require uniform texture of the exposed face throughout the length and width of the exposed unit face. All these variables require unique adjustments and machine settings to form finished products properly.

Prior art machines for forming concrete products within a mold assembly include a product forming section comprising a stationary frame, an upper compression beam and a lower stripper beam. The mold assembly includes a head assembly that is mounted on the compression beam, and a mold box that is mounted on the frame and receives concrete material from a feed drawer. An example of such a system is shown in U.S. Pat. No. 5,807,591 which describes an improved concrete products forming machine (CPM) assigned in common to the assignee of the present application and herein incorporated by reference for all purposes.

In use, the feed drawer moves concrete material over the top of the mold box and dispenses the material into the contoured cavities of the mold box. The feed drawer typically includes an agitator assembly within the drawer that operates to break up the concrete and improve its consistency prior to dropping it into the mold. As the concrete material is dispensed, a vibration system shakes the mold box to spread the concrete material evenly within the mold box cavities in order to produce a more homogeneous concrete product. A wiper assembly, mounted to the front of the feed drawer, acts to scrape excess concrete from the shoes when the feed drawer is moved to an operative position above the mold box.

After the concrete is dispensed into the mold cavities, the feed drawer retracts from over the top of the mold box. A spreader, bolted separately to the front of the feed drawer, scrapes off excess concrete from the top of the mold when the feed drawer is retracted after filling the mold cavities. The compression beam then lowers, pushing shoes from the head assembly into corresponding cavities in the mold box. The shoes compress the concrete material during the vibration process. After compression is complete, the stripper beam lowers as the head assembly pushes further into the cavities against the molded material. A molded concrete product thereby emerges from the bottom of the mold box onto a pallet and is conveyed away for curing and, simultaneously, a new pallet moved in its place beneath the underside of the mold box.

Mechanical vibration is typically accomplished by indirectly vibrating the air spring supported table under the mold with a fixed amplitude vibration of the mold. However, it has been discovered that fixed amplitude vibration induces damaging impacts and vibrations when the mold weights get high or product thicknesses get low, and this can affect not only the mold but the CPM itself. There are several known variable amplitude and variable frequency (i.e., speed) vibration systems, but these only vibrate the pallet table beneath the mold and only indirectly vibrate the mold itself. These known systems do not work as well in producing tall products and/or cored products that have stringent height tolerances, they require large power spikes during operation, and they have higher than normal cycle times.

Accordingly, there is need for an improved vibration systems for concrete products forming machines that improves upon the state of the art and overcomes these drawbacks in the prior art.

### SUMMARY OF THE INVENTION

In a first aspect of the invention, an apparatus for forming molded products comprises a frame configured to support a mold box thereon having internal cavities contoured to define preselected molded products. First and second drives operate at first and second frequencies, and at first and second phases, respectively. A vibrator is configured to impart vibrational forces to the mold box, whereby the vibrator includes a yoke extending along an expanse of the frame, and first and second, vertically extending vibrator rods eccentrically coupled at lower ends to respective first and second drives and at upper ends to the yoke in spaced-apart orientation. A central vibration rod is coupled at a lower end to the yoke between the first and second vibrator rods and extends upward to contact with the underside of the mold mounting shelf. In operation, the first vibrator rod is eccentrically moved between maximum and minimum amplitudes according to the first frequency and first phase of the first drive, and the second vibrator rod is eccentrically moved between maximum and minimum amplitudes according to the second frequency and second phase of the second drive. This then causes the central vibration rod to vibrate the mold box at a mold box vibration and frequency relative to the first and second vibrator rods.

In an alternate embodiment, an apparatus for forming concrete products comprises a frame for supporting various product forming apparatus and a mold box having internal cavities contoured to define preselected product patterns mounted to the frame. A feeder receives concrete material and selectively dispenses the concrete material into the mold box cavities. First and second drives operate at first and second frequencies, respectively, and a vibrator is configured to impart vibrational forces to the mold box. The vibrator includes a yoke having a central vibration rod coupled at a lower end to a central portion of the yoke and at an upper end adjacent to and configured to impact upon the underside of the mold mounting shelf. First and second, spaced-apart, vertically extending vibrator rods are eccentrically coupled at lower ends to the respective first and second drives and at upper ends to left and right sides of the yoke. The left side of the yoke is eccentrically lifted up to a maximum first amplitude at the first frequency and the right side of the yoke is eccentrically lifted up to a maximum second amplitude at the second frequency so that the central vibration rod impacts upon the frame and vibrates the mold box mounted to the frame at an approximate average between first and second vibrator rods.

In yet another aspect of a method and apparatus for vibrating a mold box of a type having a plurality of mold cavities sized and shaped to yield a predesignated molded product, the system comprises mounting the mold box to a frame within the expanse of a product forming machine and moving left and right sides of a yoke upward and downward independently through phases of a vibration sequence. The vibration sequence for each has a maximum and minimum lifting height such that the left and right sides of the yoke tilt with respect to one another dependent upon the vibration sequence. A central vibration rod couples between a central portion of the yoke and the frame so that the frame is vibrated at an approximate average between the upward and downward movement of the left and right sides of the yoke. Vibration frequency, amplitude, and phase difference can be adjusted to affect the vibration profile of the central vibration rod.

The new method/apparatus allows independent control of both the vibration amplitude and the frequency by using cams rotating at different rates to lift opposite ends of a yoke using “living hinges” so that a central vibration rod is raised and lowered relative to a mold box underside surface in order to achieve variable amplitude vibration at a controllable frequency. Rotating cams are directly or indirectly coupled to lift rods that connect on upper ends to right and left sides of a triangular yoke. The lift rods have “living hinges” closer along their length to allow flexion of the rod as the yoke is lifted and tilted. A vibration rod is coupled on a lower end to a center of the yoke midway between the left and right lift rods, and on an upper end to the mold. As the right and left sides of the yoke are raised and lowered at different rates by the differently rotating cams, the phase and height of the center vibration rod is changed so that the rod achieves maximal height when the cams are in phase and variable height as the cams are out of phase. The cams can be rotated in the same direction in one implementation of the invention, and in opposite directions in another.

A method for vibrating a mold box of a type having a plurality of mold cavities sized and shaped to yield a predesignated molded product is also disclosed, in which the mold box is mounted to a frame within the expanse of a product forming machine. The left and right sides of a yoke are then moved upward and downward independently through phases of a vibration sequence having maximum and minimum lifting heights such that the left and right sides of the yoke tilt with respect to one another dependent upon the vibration sequence. Finally, the central portion of the yoke is coupled to the frame so that the frame is vibrated at an approximate average between the upward and downward movement of the left and right sides of the yoke. Alternately, the first rotation rate of the first cam and the second rotation rate of the second cam can be set to be equal to one another. Then, one would adjust the rotation rate of one or both of the first and second rotation rates so that the first cam and second cam rotate at different rates relative to one another in order to effect a rotational phase difference between the first and second cams that changes over time. The first rotation rate is then set equal to the second rotation rate when the rotation phase difference between the first and second cams is equal to a desired amount. That is, the rotation rate of one is slowed down (or sped up) for a brief time until a desired phase difference is achieved at which point the rotation rates are again set equal to one another.

The foregoing and other objects, features and advantages of the invention will become more readily apparent from the following detailed description of a preferred embodiment of the invention that proceeds with reference to the accompanying drawings.

### BRIEF DESCRIPTION OF THE DRAWINGS

FIG. 1 is a perspective view of a concrete products forming machine (CPM) incorporating a vibration system implemented according to teachings of the invention.

FIG. 2 is a schematic side view showing the vibration system portion of the CPM of FIG. 1.

FIGS. 3A-3E show side elevation views of the vibration system of FIGS. 1 and 2 at five different times during a first implementation of the vibration sequence where cam rotation frequencies are different from one-another.

FIG. 4A is a graph showing the lifting positions of the vibration rods over time for the vibration system of FIGS. 3A-3E.

FIG. 4B is a graph showing the lifting position of the vibration rods over time where the rotating cams are set at a common frequency but at a 120-degree phase difference according to an alternate embodiment of the invention.

FIG. 5 is a graph showing the resulting vibration of a mold using a second implementation of the vibration sequence for various phase differences between the vibration rods.

FIG. 6 is a flow diagram illustrating an implementation of the vibration sequence according to teachings of the invention.

### DETAILED DESCRIPTION

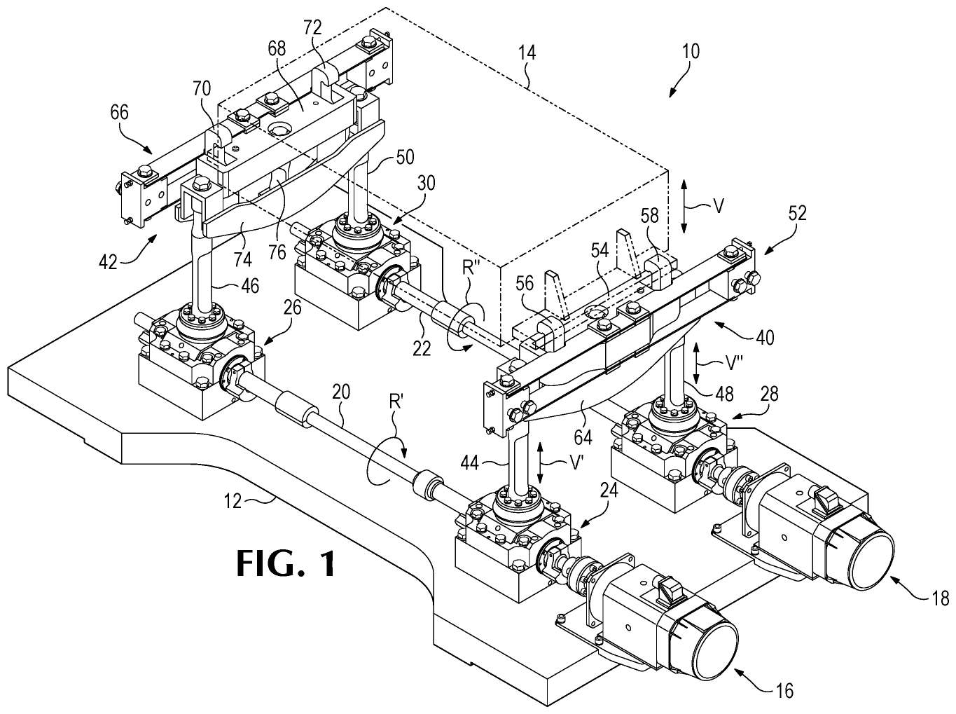

FIG. 1 illustrates a vibration system 10 as implemented according to a preferred embodiment of the invention. Vibration system 10 is shown resting on and affixed to a mounting plate 12 positioned centrally of a concrete products machine (CPM—not shown) so that it may mount a mold box 14 (shown schematically in dashed lines) thereon. Mold box 14 is configured with an open top leading to a plurality of internal cavities (not shown) whereby a moldable material such as concrete flows in from the top into the cavities. The mold box 14 is then vibrated (i.e., by vibration characteristic V) by system 10 to eliminate air within the concrete, more evenly spread the concrete within the cavities, and uniformly increase the density of the concrete being formed, which results in a more consistent molded product.

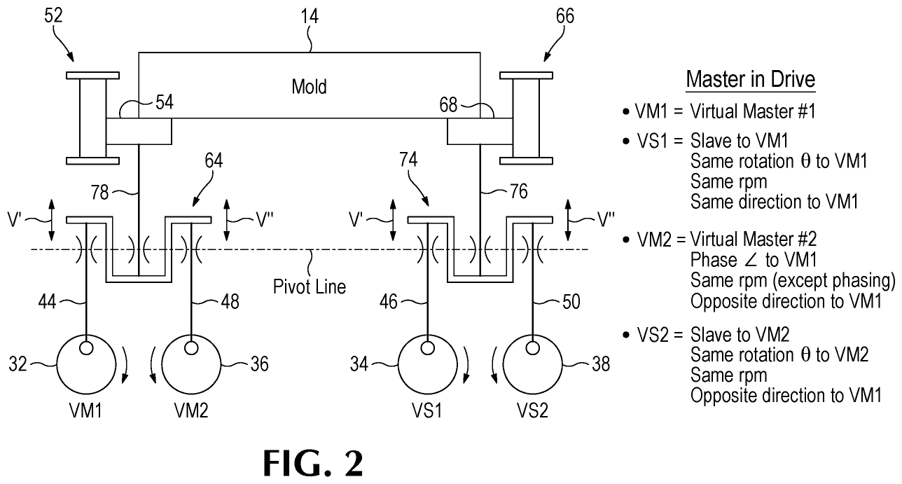

Vibration system 10 includes first and second drive motors 16, 18, coupled to respective drive shafts 20, 22, that each rotate R′, R″ at a certain rotational frequency and phase. A controller (not shown) is electrically coupled to each of the motors 16, 18 so that the operational frequency and phase of each of the motors can each be independently adjusted for purposes described further below. Drive shaft 20 passes through axially aligned vibration base assemblies mounted to platform or plate 12, including a first virtual master 24 on a right side of the vibration system 10 and first mechanical slave 26 on the left side. Similarly, drive shaft 22 runs parallel to drive shaft 20 and passes through respective vibration base assemblies mounted to platform or 15 plate 12, including a second virtual master 28 on a right side of the vibration system 10 and second mechanical slave 30 on the left side. Vertically oriented disks are mounted within the interior of the vibration base assemblies 24, 26, 28, 30 in one embodiment and respective drive shafts 20, 22 pass parallel to but off-center from a rotational axis of each of the disks so that the disks within master and slave structures 24, 26 form one set of eccentrically-rotating cams 32, 34 (FIG. 2) and those disks within master and slave structures 28, 30 form a second set of eccentrically-rotating cams 36, 38. Each of the cams then have a rising and falling upper surface that moves between maximum and minimum heights as the shafts rotate.

Vibration system 10 includes two sets of vibration assemblies, including a first assembly 40 operative to impart vibrational forces to a right side of the mold box 14 and a second assembly 42 operative to impart vibrational forces to a left side of the mold box 14. First vibration assembly 40 includes the right-side vibration base assemblies 24, 28 and respectively embedded rotating cams 32, 36. Second vibration assembly 42 includes the left-side vibration base assemblies 26, 30 and respectively embedded rotating cams 34, 38. Vertically oriented vibration rods 44, 46, 48, and 50 are engaged with respective eccentric cams 32, 34, 36, 38 at lower ends thereof and vibrate vertically between minimum and maximum heights as the cams rotate, where vibration rods 44 and 48 are included within the first vibration assembly 40 and rods 46, 50 within the second 42. Rods 44, 46 vibrate at a rate V′ relative to the rate or frequency of rotation to drive shaft 20 imparted by first motor drive 16, while rods 48, 50 vibrate at a rate V″ relative to the rate or frequency of rotation imparted to drive shaft 22 by second motor drive 18. In another aspect, lower ends of the vibration rods 44, 46, 48, and 50 are coupled off-center to the axis of rotation of their respective cams 32, 34, 36, 38 so that the rods move upward and downward according to the rotation of the cams.

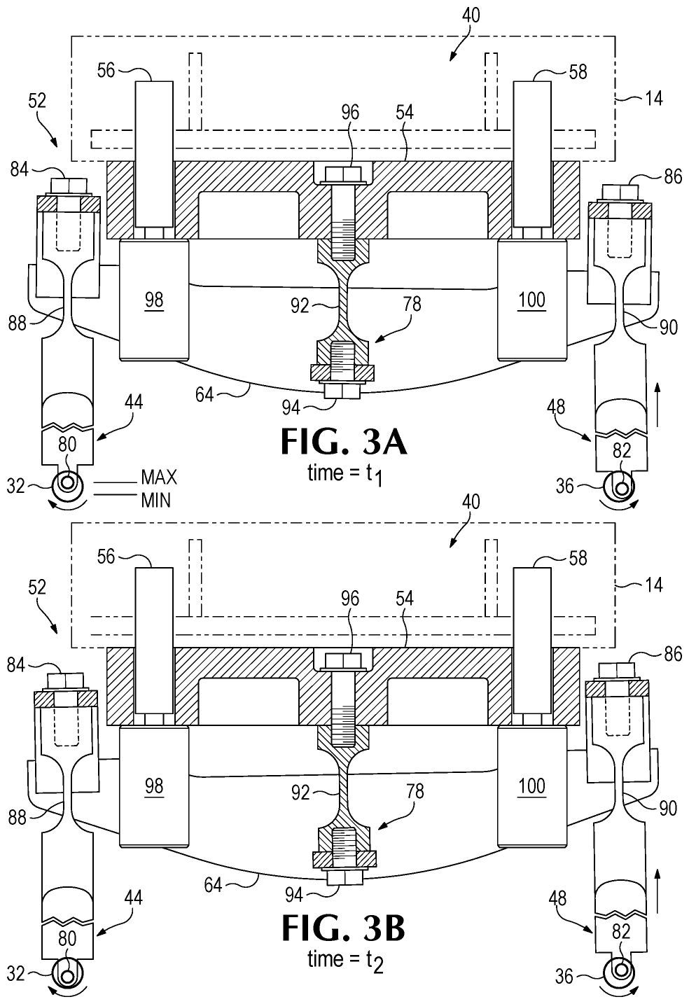

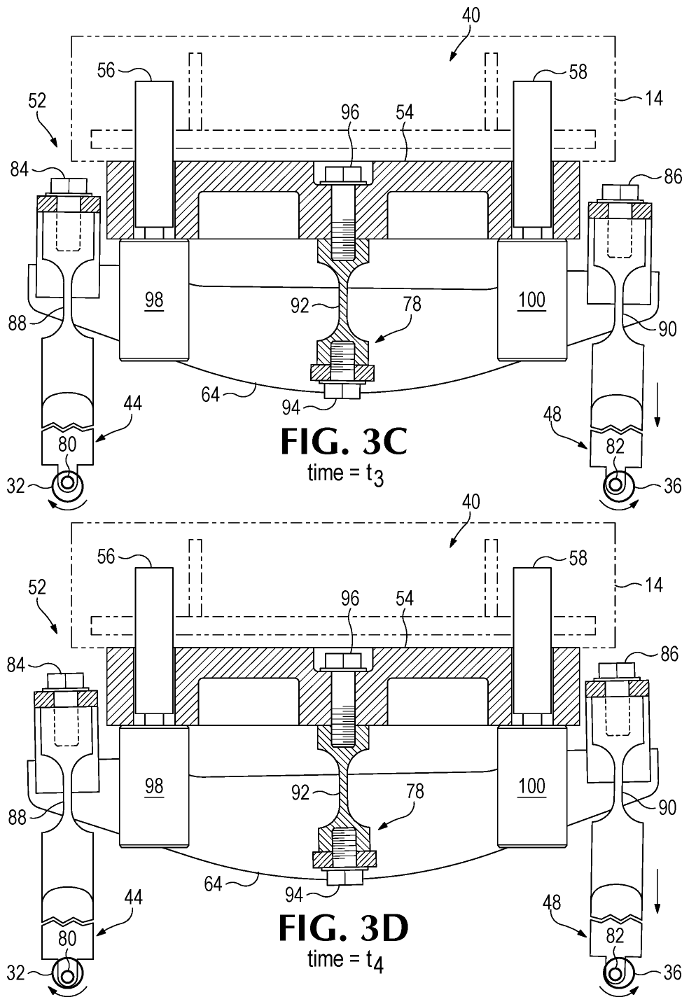

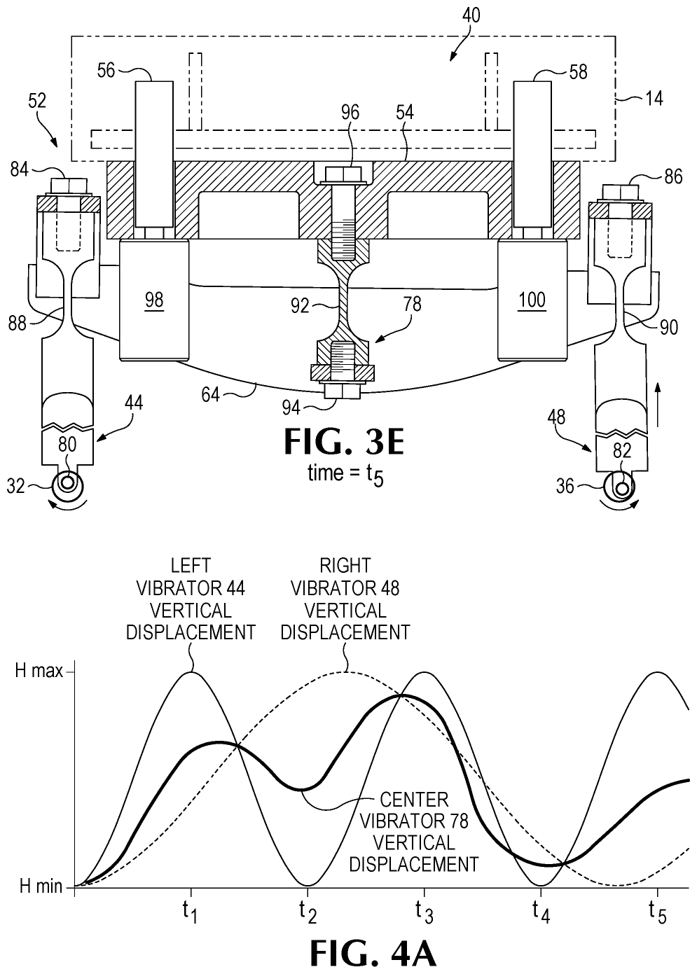

First vibration assembly 40 further comprises an upper framework 52 including an inwardly extending shelf 54 on which the right side of the mold box 14 rests. Framework 52 includes a set of vertically actuated clamps 56 and 58—operated by cylinders 60, 62 (FIGS. 3A-3E)—that releasably couple the right side of the mold box 14 to the shelf 54. Vibration rods 44, 48 couple at lower ends to respective cams 32, 36 (and, by extension, drives 16, 18) and at upper ends in spaced-apart orientation to a yoke 64 that extends along an expanse of the framework 52. Second vibration assembly 42 is similarly configured, whereby it comprises an upper framework 66 and an inwardly extending shelf 68 on which the left side of the mold box 14 rests. Framework 66 includes a set of vertically actuated clamps 70 and 72—operated by cylinders (not shown)—that releasably couple the left side of the mold box 14 to the shelf 68. Vibration rods 46, 50 couple at lower ends to respective cams 34, 38 (and, by extension, drives 16, 18) and at upper ends in spaced-apart orientation to a yoke 74 that extends along an expanse of the framework 52.

A central vibration rod is coupled at a lower end to the yoke between the spaced apart vibration rods—e.g., central vibration rod 76 coupled to yoke 74 between rods 46, 50—and extends upward to contact with the framework, e.g., left-side framework 66. Vibration rod 46 then is eccentrically vibrated V′ between maximum and minimum amplitudes according to the first frequency and first phase of the first drive 16, and the second vibrator rod 50 is eccentrically vibrated V″ between maximum and minimum amplitudes according to the second frequency and second phase of the second drive 18, whereby the central vibration rod 76 vibrates the shelf 68 and the mold box 14 clamped atop it at a mold box vibration V and frequency relative to the first and second vibrator rods 46, 50. The central vibration rod 78 (FIGS. 3A-3E) operates similarly with respect to the structure of the first vibration assembly 40, including with respect to vibration rods 44, 48 and yoke 64.

FIG. 2 illustrates a schematic of the vibration system 10 shown in FIG. 1. Cam 32 is shown as a “virtual master” VM1 that is eccentrically driven by drive shaft 20 rotated by motor 16. The rotational frequency of cam 32 matches the vibrational frequency of vibration rod 44 and amplitude of the cam dimensions and eccentricity to yield a vibration characteristic V′. Cam 34 is shown as a “virtual slave” VS1 to cam 32 (VM1) and comprises the same rotational rate (rpm), same direction (here, clockwise), and phase angle θ as VM1. Elements sharing a common main shaft axis of rotation through mechanical connection include virtual master VM1, virtual slave VS1, motor 16, cams 32, 34, and drive shaft 20 operating through base assemblies 24, 26. In contrast, cam 36 is shown as a “virtual master” VM2 that is eccentrically driven by drive shaft 22 rotated by motor 18. The rotational frequency of cam 36 matches the vibrational frequency of vibration rod 48 and amplitude of the cam dimensions and eccentricity to yield a vibration characteristic V″. Cam 38 is shown as a “virtual slave” VS2 to cam 36 (VM2) and comprises the same rotational rate (rpm), same direction (here, counterclockwise), and phase angle θ as VM2. VM1 (and slave VS1) may be phased differently from VM2 (and slave VS2) so as to adjust the max-min amplitude and other vibration characteristics imparted to central vibration rods 76, 78 as described further below. Elements sharing a common main shaft axis of rotation through mechanical connection include virtual master VM2, virtual slave VS2, motor 18, cams 36, 38, and drive shaft 22 operating through base assemblies 28, 30. Drive shafts 20, 22 can be electronically slaved to one another to effect vibration characteristics noted further below.

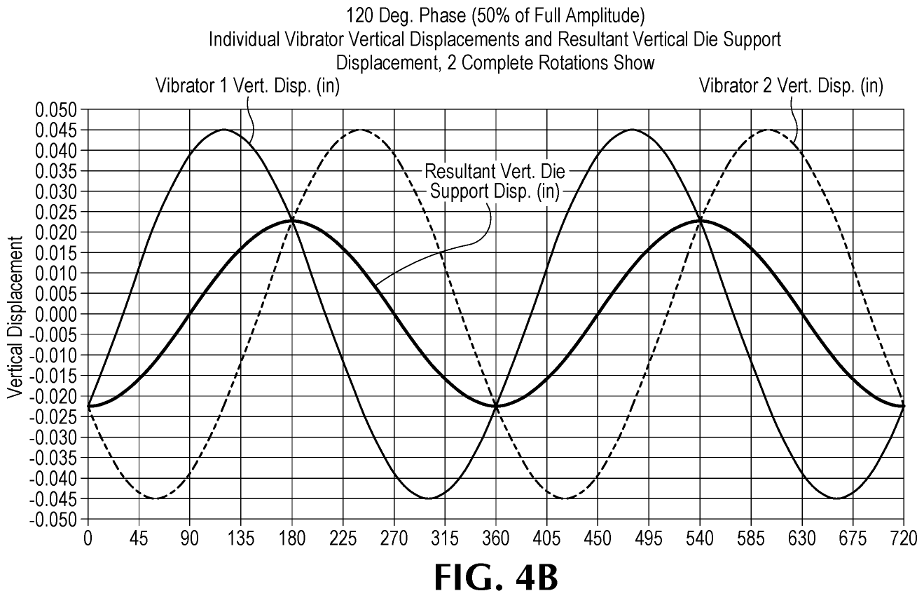

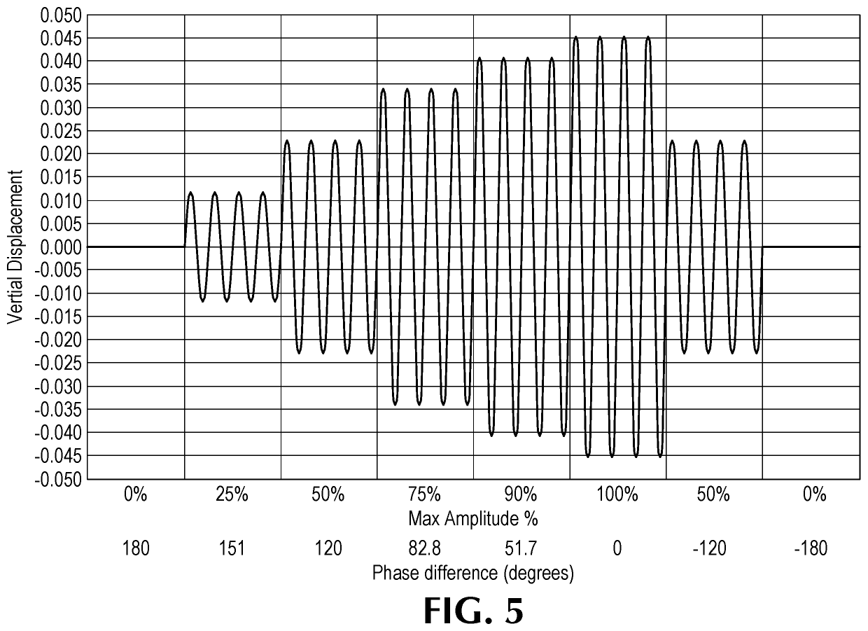

Embodiments of the invention can include characteristics whereby the first and second frequencies at which cam pairs 32, 34 and 36, 38 are driven by respective drive motors 16, 18 are equal but that cam pair 32, 34 operates at a first phase that is different from a second phase at which cam pair 36, 38 operates—in other words, the first and second phases are different. This is described in more detail below with reference to FIGS. 4B and 5. In another aspect of operation, the cam pairs 32, 34 and 36, 38 are driven at different rotational frequencies by drive motors 16, 18—as exemplified by FIGS. 3A-3E and FIG. 4A. These first and second frequencies can be whole number multiples of one another, can be rational ratios of one-another so as to provide a repeating vibration profile, or can be irrational ratios of one-another so as to effect a complicated and non-repeating vibration profile as shown best in FIG. 4A. First and second drives 16, 18 can further be configured to rotate in the same direction, although it is most preferred for balancing and reduction of vibration of the entire system 10 that the drives rotate in opposite directions to one another.

FIGS. 3A-3E illustrate a rotation cycle of the vibration system 10, and particularly the first vibration assembly 40 at time stamps t₁, t₂, t₃, t₄, t₅. In this (first) embodiment, vibration system 10 operates where the drives are rotating in opposite directions but at different phases and rotational frequencies so as to affect an irrational (non-repeating) vibration cycle shown in the chart of FIG. 4A. Parts match those shown in FIG. 1, whereby cam 32 or a lower end of the vibration rod 44 is rotated around first drive shaft 20 so that it moves eccentrically whereby a top surface of the cam or the lower end of the vibration rod moves between minimum (MIN) and maximum (MAX) heights depending upon the dimensions of the cam and how off-center the drive shaft 20 or lower end of the vibration rod 44 is coupled to the cam 32. In this example, cam 32 is being driven clockwise while cam 36 is being driven counterclockwise. The cams 32, 36 are of equal size, although it is contemplated that the cams can be sized differently so as to change the max-min height differential between the two sides. The cams 32, 36 are shown having a phase differential that changes over time due to the difference in frequency at which the two cams are being driven.

Cam 32 is pinned 80 to a tab on a lower end of vertically-extending vibration rod 44 and cam 36 is pinned 82 to a tab on a lower end of vertically-extending vibration rod 48. The datum line of this pinned location changes over time as the cams rotate, thus causing rods 44, 48 to vibrate up and down. Rod 44 is coupled at an upper end via a bolt 84 to a left side of yoke 64. Similarly, rod 48 is coupled at its upper end via a bolt 86 to a right side of yoke 64. Whereas rods 44, 48 are coupled at the terminal ends of the yoke 64, it is understood that the rods can be coupled closer together, or even asymmetrically along the length of the yoke 64, so long as there is space between them to allow attachment of the central vibration rod 78. In one variation, the central vibration rod 78 is mounted to the yoke 64 approximately midway between the first and second vibration rods 44, 48, whereby the central vibration rod 78 vibrates the mold box 14 at a frequency and amplitude approximately average between the first and second vibration rods. In other embodiments, the central vibration rod is mounted to the yoke closer to one rod 44 than the other 48 so that the vibration characteristics (e.g. amplitude) are influenced more by the closer of the two rods 44, 48.

One or more of the vertically-extending vibration rods-including rods 44, 48 and 78 include a hinge (such as living hinge 88 in rod 44) coupled along the vibrator rods. The hinge is operative to effect a bend of a top portion of the vibrator rods relative to a lower portion of the vibrator rods in order to accommodate a tilt of the yoke 64 as left and right sides of the yoke are lifted at different rates and/or to different amplitudes over time by the first and second drives 16, 18. The hinge 88—just as with hinges 90 and 92—can include a thinning area of the vibrator rods to create a more flexible portion. One notes, for instance, that the position of the vibration assembly 40 in FIG. 3A at time stamp t₁ shows the vibration rod 44 on the left side of the image being lifted more than the rod 48 on the right side (i.e., the bolt 84 is closer to the bottom surface of the mold box 14 than bolt 86). Rod 44 is at the top of its lifting cycle and about ready to go down, while rod 48 has just bottomed out and is starting to rise. This effects a tilt of the yoke 64 with respect to a horizontal datum line, thus requiring the rods to flex slightly along their hinge portions. It is understood that an alternative to hinge 92 is contemplated such as a bearing, bushing, or other rotational type connection that allows only rotation about an axis parallel to the rotation axis of the vibrators 32, 34, 36, 38 (FIG. 2) or 32/80 and 36/82 (FIGS. 3A-3E). This, then, would allow free rotation of the yoke 64 relative to the framework 52 supporting the mold.

The central vibration rod 78 is coupled at a lower end—e.g. via bolt 94—to a lower portion of the yoke 64 midway between the first vibration rod 44 and the second vibration rod 48 and at an upper end—e.g. via bolt 96—to the underside of the upper framework 52, and particularly the underside of shelf 54. The head of the bolt 96 can be recessed within the shelf upper surface 54 so as to provide a flat mounting surface for the mold box 14 when clamped thereon. Alternately, the central vibration rod 78 might not be affixed to the shelf 54 via a bolt but reciprocate freely and instead impact its upper terminal end against an underside of the framework 52 so as to impart a vibrational force to the frame. Cylinders 98, 100 engage with the clamps 56, 58 to lift the clamps for mounting/demounting the mold box to the shelf 54 or pull down on the clamps to secure the mold box 14 to the shelf upper surface.

FIG. 4A is a graph showing the lifting position of the central vibration rod 78 in a dark line as an average between the left cam 32 position (solid line) and the right cam 36 (dashed line). One notes, for instance, that thought the left and right cams rotate (and the respective vibration rods 44, 48 lift) in a periodic fashion, that the vibration profile of the central vibration rod is complex and non-periodic, moving between minimum height Hₘᵢₙ at to and near to maximum height Hₘₐₓ at t₃ where the vibration heights change in irrational fashion over time. FIG. 3B illustrates the first vibration assembly 40 at a second time stamp t₂ in FIG. 4A where the left cam 32 (and respective vibration rod 44) is at a minimum height and the right cam 36 (and respective vibration rod 48) is near a maximum height. FIG. 3C illustrates the first vibration assembly 40 at a third time stamp t₃ in FIG. 4A where the left cam 32 (and respective vibration rod 44) is at a maximum height and the right cam 36 (and respective vibration rod 48) is just past a maximum height, resulting in a position of the shelf 54 via the central vibration rod 78 at near a maximum-shown by the dark line being near Hₘₐₓ. In contrast, FIG. 3D illustrates the central vibration rod 78 at a near minimum-shown by the dark line in FIG. 4A being near Hₘᵢₙ. Finally, the vibration system 10 is near a midway between Hₘₐₓ and Hₘᵢₙ due to the left cam 32 being as Hₘₐₓ and the right cam being just past Hₘᵢₙ, with the central rod 78 lifting position being an average between the two.

FIG. 4B is a graph illustrating the resulting vibration amplitude and period (dark line) when the drive motors 16, 18 are set to rotate in opposite directions at an equal frequency with a 120-degree phase difference. The vertical displacement (y-axis) of vibration rod 44 over time (x-axis) is shown in a solid line while that of vibration rod 48 is shown as a dashed line. The vertical displacement of the central vibration rod 78 is shown as a dark line, where it is apparent that a phase difference results in reducing the max/min displacement from zero. FIG. 5 further illustrates this difference by plotting displacement of the central vibration rod 78 over time based on phase difference between drive motors 16, 18. That is, a 180° phase difference between motors 16, 18 results in an effective cancellation of vibration—that is, when one vibration is up, the other is down, and vice versa. A 151° phase difference between motors 16, 18 results in a max/min displacement of central vibration rod 78 of 25% from the max/min (e.g., Hₘₐₓ/Hₘᵢₙ) of vibration rods 44, 48. At 120° phase difference this is 50%. At 82.8° phase difference this is 75%. At 51.7° phase difference this is 90%. And at 0° phase difference this is 100%—i.e., both vibration rods 44, 48 are lifting and lowering together.

A method for vibrating a mold box of a type having a plurality of mold cavities sized and shaped to yield a predesignated molded product is also disclosed, in which the mold box is mounted to an upper framework 52 within the expanse of a product forming machine. The left and right sides of a yoke, e.g. yoke 64, are then moved upward and downward independently through phases of a vibration sequence having maximum and minimum lifting heights such that the left and right sides of the yoke tilt with respect to one another dependent upon the vibration sequence. Finally, the central portion of the yoke is coupled to the frame so that the frame is vibrated at an approximate average between the upward and downward movement of the left and right sides of the yoke.

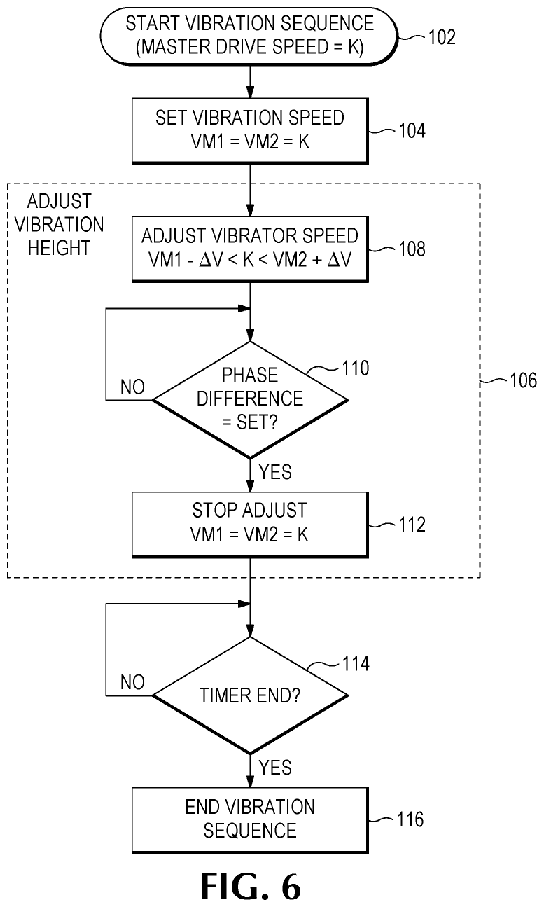

The step of moving the left and right sides of the yoke include driving a first cam 32 at a first rotation rate and direction for eccentric movement through a first cam rotation sequence. A first vibration rod 44 is coupled between the first cam 32 and the left side of the yoke 64 so that the left side moves upward and downward dependent upon rotation of the first cam. One then independently drives a second cam 36 at a second rotation rate and direction for eccentric movement through a second cam rotation sequence. In this vibration sequence method, the rotation directions are preferably different, the rotation rates the same (but momentarily different as noted below with reference to FIG. 6), and the phases typically different depending upon the desired vibration height as shown in FIG. 5. A second vibration rod is coupled between the second cam 36 and the right side of the yoke 64 so that the right side moves upward and downward dependent upon rotation of the second cam. Finally, a central vibration rod 78 is coupled between a center portion of the cam and the frame 52 where a lower end of the central vibration rod moves relative to an approximate average between the first and second vibration rod.

FIG. 6 is a flow diagram illustrating a method for changing the phase difference between each of the side vibration rods 44, 48 within a vibration assembly 40. In block 102, the vibration sequence is started and both motors 16, 18 set to a master drive speed equal to K. This then sets in block 104 the virtual masters VM1=VM2=K where the first rotation rate of the first cam and the second rotation rate of the second cam can be set to be equal to one another. To adjust the vibration height in subsequence 106, one would adjust the rotation rate of one or both of the first and second rotation rates so that the first cam and second cam rotate at different rates relative to one another in order to effect a rotational phase difference between the first and second cams changes over time. This can be accomplished in block 108 by adjusting the vibrator speed of one vibrator by a certain amount (ΔV) while increasing the vibrator speed by an equal amount so that VM1−ΔV<K<VM2+ΔV. The vibrator speed is adjusted in this fashion until a desired phase difference between the drives 16, 18 is achieved in query block 110. Once the desired phase difference is achieved, the operator would operate block 112 to again set the vibration speed equal to one another so that VM1=VM2=K. Query block 114 would then detect whether the vibration sequence timer ends, at which point the sequence would proceed to block 116 and thus end. Alternatively, the rotation rate of one is slowed down (or sped up) for a brief time until a desired phase difference is achieved at which point the rotation rates are again set equal to one another. In all methods, however, the mold box is mounted to the frame, as by clamping the mold box to a top of the frame, so that the mold box vibrates at the same frequency and amplitude as the frame.

An advantage of the design is that one is able to maintain more consistent height and density of the molded products. By mechanically vibrating the mold and using a reactive steel production pallet supported by an air spring supported table under the mold, one can achieve the most consistent cross-sectional density and height control than any other process.

With a variable amplitude and variable frequency (speed) vibration system, the systems need not be mechanically tied to the vibration of the mold and works by inducing a vibration in a pallet table that then induces a reactionary mold vibration through impacting a steel production pallet. Reactionary mold vibration systems (RMV) seem to work especially well for making products that have less stringent height tolerances or where large production pallet sizes and therefore heavy molds combined with very high product densities are desired. But being able to choose a desired amplitude at any operating frequency would increase the versatility of the machine while reducing the detrimental effects of heavy molds by being able to lower the vibration amplitude. There is also a possible advantage related to decreasing the spikes in energy requirements to accelerate the molds from zero speed up to the desired operating speed. Lastly, the ability to change speeds and vibration amplitudes independently may also allow for unique combinations that could reduce the overall cycle time of the equipment.

Having described and illustrated the principles of the invention in a preferred embodiment thereof, it should be apparent that the invention can be modified in arrangement and detail without departing from such principles. Accordingly, we claim all modifications and variation coming within the spirit and scope of the following claims.

What is claimed is:

1. An apparatus for forming molded products comprising:
a frame configured to support a mold box thereon having internal cavities contoured to define preselected molded products;
first and second drives operating at first and second frequencies, and at first a second phases, respectively; and
a vibrator configured to impart vibrational forces to the mold box, the vibrator including:
a yoke extending along an expanse of the frame;
first and second, vertically extending vibrator rods eccentrically coupled at lower ends to respective first and second drives and at upper ends to the yoke in spaced-apart orientation;
a central vibration rod coupled at a lower end to the yoke between the first and second vibrator rods and extending upward to contact with the frame, wherein the first vibrator rod is eccentrically moved between maximum and minimum amplitudes according to the first frequency and first phase of the first drive, and the second vibrator rod is eccentrically moved between maximum and minimum amplitudes according to the second frequency and second phase, whereby the central vibration rod vibrates the mold box at a mold box vibration and frequency relative to the first and second vibrator rods.

2. The apparatus of claim 1, wherein the first and second frequencies are equal and the first and second phases are different.

3. The apparatus of claim 1, wherein the first and second frequencies are different from one another.

4. The apparatus of claim 3, wherein the first and second frequencies are not whole number multiples of one another.

5. The apparatus of claim 1, wherein the first a second drives are configured to rotate in opposite directions to one another.

6. The apparatus of claim 1, wherein the central vibration rod is mounted to the yoke approximately midway between the first and second vibration rods, whereby the central vibration rod vibrates the mold box at a frequency and amplitude approximately average between the first and second vibration rod.

7. The apparatus of claim 1, further including a hinge coupled along the first and second vibrator rods and operative to effect a bend of a top portion of the vibrator rods relative to a lower portion of the vibrator rods in order to accommodate a tilt of the yoke as left and right sides of the yoke are lifted at different rates and/or to different amplitudes over time by the first and second drives.

8. The apparatus of claim 7, wherein the hinge includes a thinning area of the vibrator rods to create a more flexible portion.

9. The apparatus of claim 1, further including a control operatively coupled to the first and second drives and configured to enable an operator to adjust the first frequency and second frequency.

10. The apparatus of claim 1, further including a control operatively coupled to at least one of the first and second drives and configured to enable an operator to adjust a phase difference between the first and second drive.

11. The apparatus of claim 1, further including:
a second yoke extending along an opposite expanse of the frame;
a first slave vibrator rod eccentrically coupled at a lower end to the first drive and at upper end to one side of the second yoke;
a second slave vibrator rod eccentrically coupled at a lower end to the second drive and at an upper end of an opposite side of the second yoke, so that the first and second slave vibrator rods are in spaced-apart orientation;
a second central vibration rod coupled at a lower end to the second yoke between the first and second slave vibrator rods and extending upward to contact with the frame, wherein the first slave vibrator rod is eccentrically moved between maximum and minimum amplitudes according to the first frequency and first phase of the first drive, and the second slave vibrator rod is eccentrically moved between maximum and minimum amplitudes according to the second frequency and second phase, whereby the second central vibration rod vibrates the mold box at an mold box vibration and frequency relative to the first and second slave vibrator rods.

12. A method for vibrating a mold box of a type having a plurality of mold cavities sized and shaped to yield a predesignated molded product, the method comprising
mounting the mold box to a frame within the expanse of a product forming machine;
moving left and right sides of a yoke upward and downward independently through phases of a vibration sequence having maximum and minimum lifting heights such that the left and right sides of the yoke tilt with respect to one another dependent upon the vibration sequence; and
coupling a central portion of the yoke to the frame so that the frame is vibrated at an approximate average between the upward and downward movement of the left and right sides of the yoke.

13. The method of claim 12, wherein the step of moving the left and right sides of the yoke include:
driving a first cam at a first rotation rate and direction for eccentric movement through a first cam rotation sequence;
coupling a first vibration rod between the first cam and the left side of the yoke so that the left side moves upward and downward dependent upon rotation of the first cam;
independently driving a second cam at a second rotation rate and direction for eccentric movement through a second cam rotation sequence;
coupling a second vibration rod between the second cam and the right side of the yoke so that the right side moves upward and downward dependent upon rotation of the second cam; and
coupling a central vibration rod between a center portion of the cam and the frame where a lower end of the central vibration rod moves relative to an approximate average between the first and second vibration rod.

14. The method of claim 13, further including the step of rotating the first cam and second cam in different directions.

15. The method of claim 13, further including the step of rotating the first cam and second cam at different frequencies.

16. The method of claim 13, further including the step of rotating the first cam and second cam at a different phase with respect to one another.

17. The method of claim 16, further including the step of selecting a different phase from a list of such different phases including a group consisting of 180 degrees, 151 degrees, 120 degrees, 82.8 degrees, 51.7 degrees, −120 degrees, and −180 degrees.

18. The method of claim 13, wherein the step of coupling the central vibration rod includes impacting a terminal end of the central vibration rod with an underside of the frame to impart vibration force to the frame.

19. The method of claim 13, further including the steps of:
setting the first rotation rate of the first cam and the second rotation rate of the second cam equal to one another;
adjusting the rotation rate of one of the first and second rotation rates so that the first cam and second cam rotate at different rates relative to one another in order to effect a rotational phase difference between the first and second cams changes over time; and
setting the first rotation rate equal to the second rotation rate when the rotation phase difference between the first and second cams is equal to a desired amount.

20. The method of claim 12, wherein the step of mounting the mold box to the frame includes clamping the mold box to a top of the frame so that the mold box vibrates at the same frequency and amplitude as the frame.
